(19) United States
(12) Patent Application Publication
(10) Pub. No.: US 2021/0374887 A1
(43) Pub. Date: Dec. 2, 2021

(54) REAL ESTATE TOOL

(71) Applicant: The Design People, Inc. DBA Agent Image, El Segundo, CA (US)

(72) Inventors: Jon Krabbe, El Segundo, CA (US); Brian Shoor, El Segundo, CA (US)

(73) Assignee: The Design People, Inc. DBA Agent Image, El Segundo, CA (US)

(21) Appl. No.: 17/337,122

(22) Filed: Jun. 2, 2021

Related U.S. Application Data
(60) Provisional application No. 63/033,778, filed on Jun. 2, 2020.

(51) Int. Cl. G06Q 50/16; G06Q 30/02; G06Q 50/00; H04L 29/06

(52) U.S. Cl. CPC G06Q 50/163; H04L 65/4023; G06Q 50/01; G06Q 30/0283

(57) ABSTRACT

A computerized system for real estate listings, comprising: (1) a listing module, comprising a backend interface configured to receive information about a real estate listing, the listing module further configured to store the received information in a centralized real estate listing database, wherein the information about the real estate listing comprises a virtual open house presentation, the virtual open house presentation comprising pricing information about the property, pictures and/or videos of the property, a virtual tour of the property, and an interactive neighborhood map; (2) a virtual open house module configured to provide the virtual open house presentation to a potential purchaser of the real estate listing via an online interface, wherein the virtual open house presentation comprises a contact feature enabling the potential purchaser to contact a real estate agent by text, email, telephone, online chat, or to conduct a video call with the real estate agent; and (3) a communication module configured to: (i) receive a request from the potential purchaser to contact the real estate agent or to conduct the video call with the real estate agent; and (ii) communicate the request to the real estate agent.

### CROSS-REFERENCE TO RELATED APPLICATION

The present application claims priority to and the benefit of U.S. Provisional Patent Application Ser. No. 63/033,778, filed on Jun. 2, 2020 and entitled “Real Estate Tool,” the entire contents of which are hereby incorporated by reference in their entirety.

### FIELD OF THE DISCLOSURE

The present disclosure is directed generally to methods and systems enabling the creation of a digital customized real estate listing presentation on a comprehensive branded virtual platform.

### BACKGROUND

Real estate listings have become increasingly digital as buyers move to online searching and research. Accordingly, it is increasingly important that real estate owners and real estate agents provide online digital information to potential buyers in a convenient and easy-to-use format that enables searching and listing review.

However, existing tools for online presentation of real estate listings and information are bulky and inconvenient. Further, the many different tools that could be beneficial or useful for a real estate owner or real estate agent are not connected or otherwise accumulated in a convenient way. Thus, the owner or agent must be versed in the many different available tools, and must spend valuable time working with the different tools to achieve a singular goal.

### SUMMARY OF THE DISCLOSURE

Accordingly, there is a continued need in the art for real estate listing tools and systems that combine many different aspects of real estate into a single interface or system. There is further a continued need for real estate listing tools and systems that combine that are easy and convenient to use.

According to an aspect, the real estate listing tool comprises a presentation/listing platform/system. The disclosure is intended to assist in the representation of a real estate listing in favor of an individual or a company. The disclosure allows branding of each real estate presentation/listing and has the capacity to incorporate third-party technology.

According to an aspect, a system for online real estate listing is provided. The system comprises: (i) a listing module, comprising a backend interface configured to receive information about a real estate listing, the listing module further configured to store the received information in a centralized real estate listing database, wherein the information about the real estate listing comprises a virtual open house presentation, the virtual open house presentation comprising pricing information about the property, pictures and/or videos of the property, a virtual tour of the property, and an interactive neighborhood map; (ii) a virtual open house module configured to provide the virtual open house presentation to a potential purchaser of the real estate listing via an online interface, wherein the virtual open house presentation comprises at least marketing material, and a contact feature enabling the potential purchaser to contact a real estate agent by text, email, telephone, online chat, or to conduct a video call with the real estate agent; and (iii) a communication module configured to: (1) receive a request from the potential purchaser to contact the real estate agent or to conduct the video call with the real estate agent; and (2) communicate the request to the real estate agent.

According to an embodiment, the information about the real estate listing further comprises one or more of sold comparable listings, development information, open house information, information about a brokerage listing the property, and information about a real estate agent listing the property.

According to an embodiment, the virtual open house presentation further comprises a floorplan for the property, and one or more links for sharing the real estate listing by social media or email.

According to an embodiment, the interactive neighborhood map comprises information about one or more of a local school, restaurant, shop, park, and museum, and further comprises demographic information about the neighborhood.

According to an embodiment, the centralized database comprises information about a plurality of real estate listings, and wherein the plurality of real estate listings are searchable by the potential purchaser.

According to an embodiment, the virtual open house presentation comprises branding of the real estate agent or a brokerage listing the property.

According to an embodiment, the virtual open house presentation comprises a testimonial about the real estate agent or a brokerage listing the property.

According to an embodiment, at least a portion of the virtual open house presentation is three-dimensional.

According to an embodiment, the virtual open house presentation comprises a template configured for construction of the virtual open house presentation.

According to an embodiment, at least a portion of the virtual open house presentation is automatically updated with new information.

According to a second aspect is a method for providing a real estate listing. The method comprises: (i) providing a real estate listing system comprising: a listing module configured to receive information about a real estate listing and a virtual open house module configured to generate and provide a virtual open house presentation to a potential purchaser of the real estate listing via an online interface; (ii) receiving, by the listing module, the information about the real estate listing; (iii) generating, by the virtual open house module using the received information about the real estate listing, the virtual open house presentation, wherein the virtual open house presentation comprises a contact feature; (iv) providing the generated virtual open house presentation to a viewer; (v) receiving, by the real estate listing system from the viewer via the contact feature, a communication request from the viewer about the virtual open house presentation; and (vi) communicating the received communication request.

These and other aspects of the invention will be apparent from the embodiment(s) described hereinafter.

### BRIEF DESCRIPTION OF THE DRAWINGS

In the drawings, like reference characters generally refer to the same parts throughout the different views. The figures showing features and ways of implementing various embodiments and are not to be construed as being limiting to other possible embodiments falling within the scope of the attached claims. Also, the drawings are not necessarily to scale, emphasis instead generally being placed upon illustrating the principles of the various embodiments.

FIG. 1 is a flowchart of a method for real estate listing, in accordance with an embodiment.

FIG. 2 is a schematic representation of a real estate listing system, in accordance with an embodiment.

FIG. 3 is a flowchart of a method for listing a real estate listing using a real estate listing system, in accordance with an embodiment.

FIG. 4 is a flowchart of a method for creating and providing a real estate presentation using a real estate listing system, in accordance with an embodiment.

FIG. 5 is a schematic representation of a dashboard module of a real estate listing system, in accordance with an embodiment.

FIG. 6 is a schematic representation of a presentation editor module of a real estate listing system, in accordance with an embodiment.

FIG. 7 is a schematic representation of a communication module of a real estate listing system, in accordance with an embodiment.

FIG. 8 is a schematic representation of an overview module of a real estate listing system, in accordance with an embodiment.

FIG. 9 is a schematic representation of an overview listing module of a real estate listing system, in accordance with an embodiment.

FIG. 10 is a schematic representation of a cover section for an online listing presentation and open house products of a real estate listing system, in accordance with an embodiment.

FIG. 11 is a schematic representation of a media gallery section for an online listing presentation and open house products of a real estate listing system, in accordance with an embodiment.

FIG. 12 is a schematic representation of a property information section for an online listing presentation and open house products of a real estate listing system, in accordance with an embodiment.

FIG. 13 is a schematic representation of a property map section for an online listing presentation and open house products of a real estate listing system, in accordance with an embodiment.

FIG. 14 is a schematic representation of a virtual tour section for an online listing presentation and open house products of a real estate listing system, in accordance with an embodiment.

FIG. 15 is a schematic representation of a real estate listing system, in accordance with an embodiment.

### DETAILED DESCRIPTION OF EMBODIMENTS

According to an embodiment, the system is an application both browser and app based. It functions as an interactive listing presentation for real estate agents and brokers they can present in person or remotely to prospective clients, as a virtual open house application and comprehensive virtual tour platform.

In a single application the tool will enable real estate professionals to create branded listing presentations themselves through an easy-to-use backend interface where they can upload property data, photos, audio and videos (such as property, agent, marketing, and etc., produced by the agent or brokerage, or sourced through third-party platforms or websites), property pricing data, sold comparable listings (CMA), development information, preview of open house application, branded marketing information about the brokerage and details on the listing agent.

Once the agent obtains the listing, the tool enables them to build a comprehensive virtual open house presentation that can be sent to prospective buyers, linked to existing MLS listings and other listing sources as well as act as an interactive open house registry at physical open houses. This part of the application will build out a more detailed picture of a listing than anything else on the market. It will include the property details, interactive neighborhood map (with school, restaurant, shopping, parks, museums and demographics based on data integration), videos (property including walk-throughs and rooms, agent, marketing, etc.), expansive property photo gallery, virtual tour gallery for one or multiple third party virtual tours, optional floorplan section (designed to be interactive and link to videos of each respective living space depicted in the floorplan), information about the agent and broker and a contact feature that allows visitors to contact the agent via form submission, schedule a video call to be hosted through the app/browser itself and to share the open house/listing via social media and forward to a friend via email.

Once the data is entered via the backend by the agent, the application can provide the most comprehensive virtual tour/walkthrough ever developed for the industry. As every agent creates these interactive property listings, they can be housed on a centralized site producing a global property database with the most detailed property information ever collected on every home that is listed. This data can be syndicated to a website that is searchable globally and act as a global multiple listing database for the agents, by the agents. The agent can customize the output to produce a beautifully branded presentation. They can select from premade designs and custom branded skins. Brokerages will also be able to license these for their agents and have special branded versions created specifically to the brokerage.

According to an embodiment, partnership opportunities will also exist for the sold data (comparative market analysis—CMA) utilizing established major real estate data aggregators that consumers are already familiar with. According to an embodiment, data aggregation can include processing and collection of the following fields (although the list is not limited): number of views, heat mapping, time spent on each property page, and/or engagements (shares, likes, promotions, etc.), among many other types of data. This data can be stored by the real estate listing system in a local or remote database.

The idea is to bring together various, online technologies into one place so real estate agents can maximize the benefit of their function when it comes to listing presentations to sellers and open houses. This is a two-part tool.

The first part is a Listing Presentation with the intent to the listings of sellers. The product includes the ability to incorporate photos, interactive maps, video from various sources, areas to maximize marketing and branding pitch pieces, comp information, track record, comparative data, as well as areas to feature an agent's testimonials, accolades, social media and contact information. All wrapped in a top level, branded design and easily shareable across multiple platforms.

The second part of the tool picks up once the Listing Presentation has done its job and the listing has been obtained by the agent and is ready to show. Queue the Online Open House. In the same fashion, the tool brings the power of various, online technologies into one place to enhance their overall function and the visitor's experience. Given the agent will have specific, property related information, property specific photos, videos, floor plans, and even 3rd party virtual tours can all be incorporated in the open house to go along with the interactive map and branding pages. Additionally, visitors will have the ability to chat/message, leave a message, schedule a call, do a live video call with the agent, and share all through the Open House/Virtual Visit tool. The ultimate sharing experience and a marketing power piece in it of itself. Again, branded and laid out in a professional design unmatched in the industry.

All of the above has been created in a user-friendly layout for the consumer and a backend designed to run on the agent's abilities once set up. The goal in this first pass of the tool is to create a consumer experience of everything but the smell and touch of a property.

There is no tool in the market that does all of these things under one roof. While there are several tools in the marketplace that do some of these things, there is no one platform that houses them all and maximizes their capabilities to tell the story all while branding to the real estate agent. The tool is designed to act as a pre-listing and listing presentation tool as well as both a virtual open house more complete than anything ever assembled as well as a buyer presentation tool for properties with far greater branding and presentation capabilities than those provided by brokers. It can also provide the same features for developers of single-family homes and multi-unit developments.

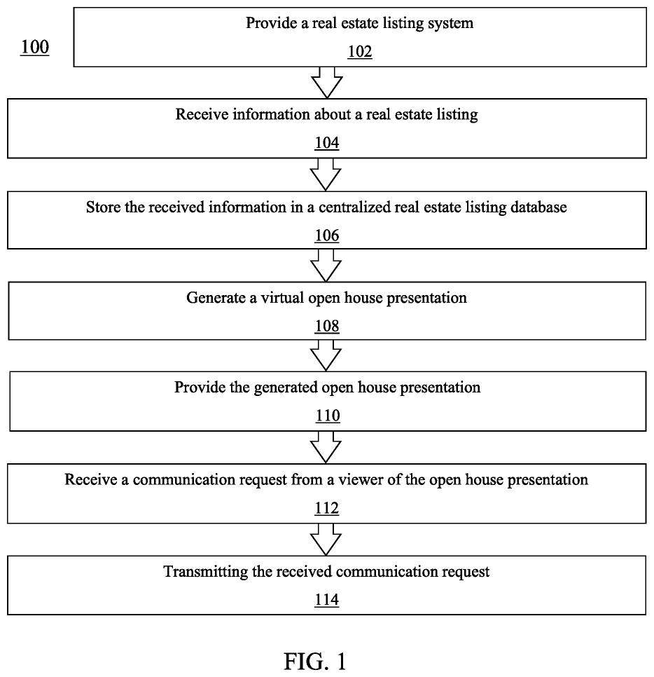

Referring to FIG. 1, in one embodiment, is a flowchart of a method 100 for providing real estate listings using a real estate listing system. The methods described in connection with the figures are provided as examples only, and shall be understood not to limit the scope of the disclosure. The real estate listing system can be any of the systems described or otherwise envisioned herein. The real estate listing system can be a single system or multiple different systems.

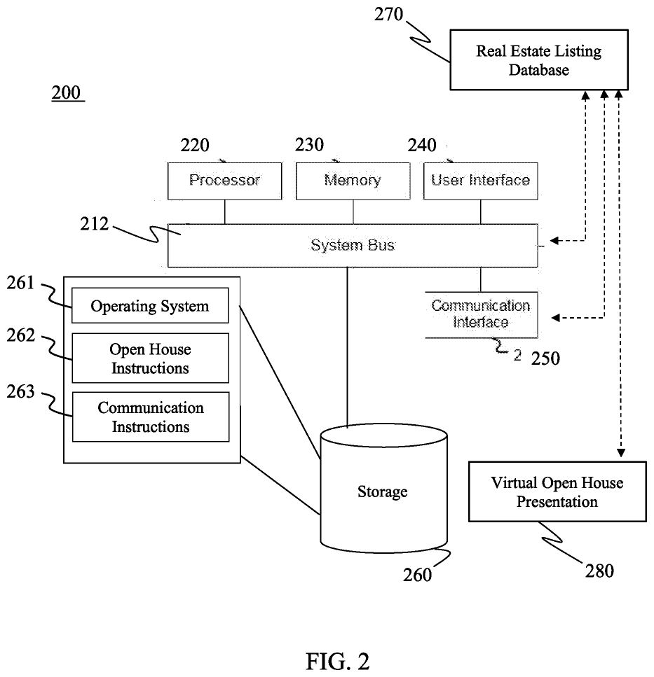

At step 102 of the method, a real estate listing system 200 is provided. Referring to an embodiment of a real estate listing system 200 as depicted in FIG. 2, for example, the system comprises one or more of a processor 220, memory 230, user interface 240, communications interface 250, and storage 260, interconnected via one or more system buses 212. It will be understood that FIG. 2 constitutes, in some respects, an abstraction and that the actual organization of the components of the system 200 may be different and more complex than illustrated. Additionally, real estate listing system 200 can be any of the systems described or otherwise envisioned herein. Other elements and components of system 200 are disclosed and/or envisioned elsewhere herein.

According to an embodiment, the real estate listing system comprises or is in direct or indirect communication with a centralized real estate listing database 270. The centralized real estate listing database comprises, among other possible data, information about a plurality of real estate listings. Each of the real estate listings can comprise a wide variety of information about the subject property, including but not limited to pricing information about the property, pictures and/or videos of the property, a virtual tour of the property, an interactive neighborhood map, sold comparable listings, development information, open house information, information about a brokerage listing the property, and/or information about a real estate agent listing the property, among many other types of information. The centralized real estate listing database can be any such database or system, including but not limited to the databases and systems described or otherwise envisioned herein.

According to an embodiment, the system 200 or centralized real estate listing database 270 comprises or is in direct or indirect communication with a virtual open house presentation module or database 280. The virtual open house presentation module or database 280 is configured to provide a virtual open house presentation to a potential purchaser of the real estate listing via an online interface. According to an embodiment, the virtual open house presentation comprises one or more of a contact feature enabling the potential purchaser to contact a real estate agent by text, email, telephone, online chat, or to conduct a video call with the real estate agent, among other information.

At step 104 of the method, the real estate listing system 200 receives information about a real estate listing. According to an embodiment, the real estate listing system comprises a backend interface that communicates or otherwise receives information from an entity listing a property, such as a real estate agent or other individual or entity. The backend interface of system 200, which can be the user interface 240, can be presented to a user via the internet or other wired and/or wireless communication system. Thus, the entity entering the information can enter that information from anywhere in the world that has access to the internet or other wired and/or wireless communication system.

The information about the real estate listing can be any information about a property or a location of a property, for example. According to an embodiment, the real estate listing information can comprise, for example, one or more of a virtual open house presentation, pricing information about the property, pictures and/or videos of the property, a virtual tour of the property, and an interactive neighborhood map, among a great variety of other types of information.

At step 106 of the method, the real estate listing system 200 stores the received information in a database such as database 260 and/or the real estate listing database 270.

At step 108 of the method, the real estate listing system 200 generates, at the direction of a real estate agent or other entity and utilizing the information provided in step 104 and stored in step 108, a virtual open house presentation. For example, the real estate listing system 200 can comprise a virtual open house presentation module configured to generate and provide a virtual open house presentation. The virtual open house presentation can comprise any information about the real estate listing. For example, the presentation can comprise one or more of pricing information about the property, pictures and/or videos of the property, a virtual tour of the property, an interactive neighborhood map, sold comparable listings, development information, open house information, information about a brokerage listing the property, and/or information about a real estate agent listing the property, among many other types of information. The virtual open house presentation can be generated by the virtual open house presentation module from information stored or otherwise found entirely within the real estate listing system 200, or can comprise information from both: (1) the real estate listing system; and (2) one or more external databases or other sources of information, wherein the real estate listing system is in communication with the one or more external databases and is configured to receive or request information from the databases.

At step 110 of the method, the real estate listing system 200 provides the generated open house presentation. According to an embodiment, the system may provide the generated open house presentation upon receiving a request from a remote user. For example, a user may search for or otherwise identify or find a real estate listing, which includes a connected or linked open house presentation. The user may then request access or to otherwise view or experience the connected or linked open house presentation, such as by clicking a link or otherwise requesting access. In response to the click or request, the real estate listing system 200 provides the generated open house presentation via a browser, video, slide deck, or other presentation mechanism. According to an embodiment, the system transmits a stored virtual open house presentation to a user's browser via the internet. The viewed presentation can be manipulatable in one or more ways, including options to stop or start the presentation, links for more information, and other manipulations.

According to an embodiment, the virtual open house presentation comprises a contact feature enabling the potential purchaser to contact a real estate agent by text, email, telephone, online chat, or to conduct a video call with the real estate agent, among other information. For example, the system may provide, along with or as part of the virtual open house presentation, a contact button or other user-activated option for initiating or requesting contact.

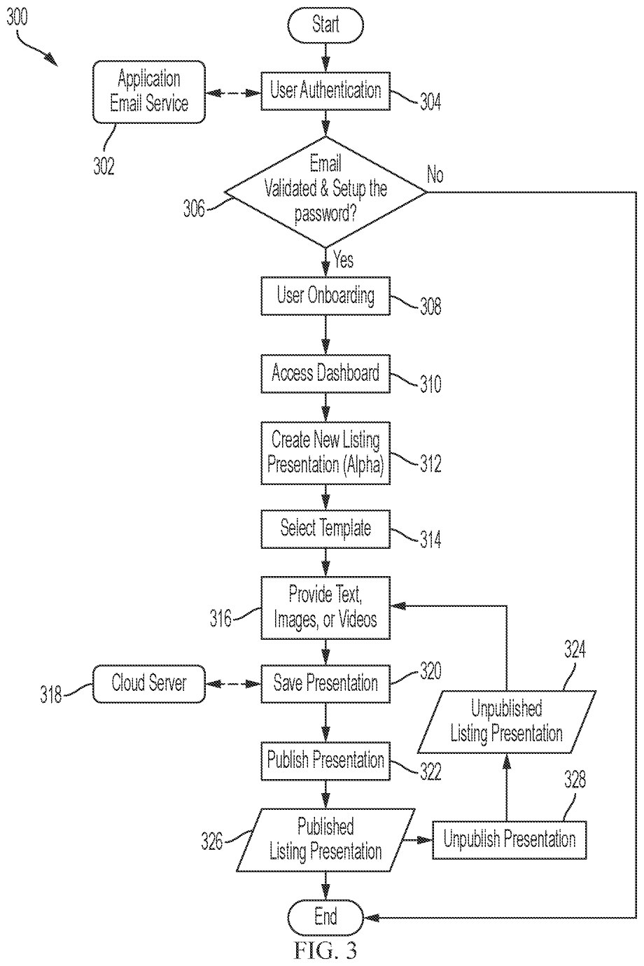

Referring to FIG. 3, in one embodiment, is a flowchart of a method 300 for listing a real estate listing using a listing module of a real estate listing system. The listing module and the real estate listing system can be any of the modules and systems described or otherwise envisioned herein. At 304 a user is authenticated, such as through an email service 302 or any other authentication method. At 306, if the email is validated and the new or returning user has setup a password, the system progresses to step 308 (if not, the system can return to the beginning or end). At 308, the user is onboarded, which can encompass any method or system and information for onboarding. At 310, the user gets access to the access dashboard via which the user can see information about existing listings or provide new information for new listings. At step 4312 of the method, the user creates a new listing. For example, at step 314 the user can select one of a plurality of possible templates for the listing. At step 316, the user can provide text, images, video, or anything else for the listing. At step 320, the system saves the listing information in local and/or remote storage, such as cloud server 318. At step 322, the system publishes the listing, for example making the listing available for viewers, resulting in an available published listing at step 326. If there are any issues or the listing is inactivated or not utilized, the system may comprise an unpublished listing 328 or 324, and may need more information.

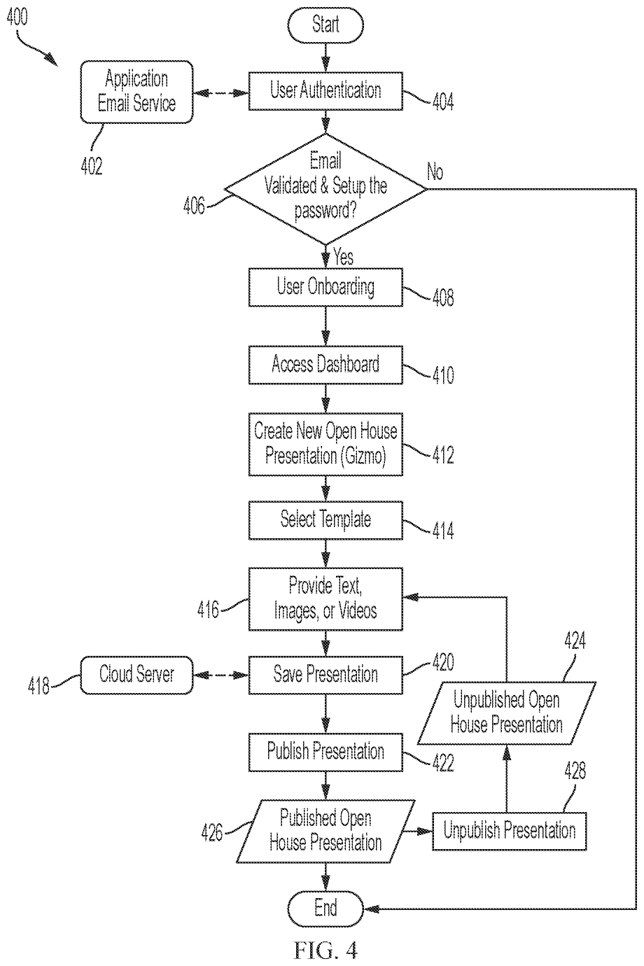

Referring to FIG. 4, in one embodiment, is a flowchart of a method 400 for creating and providing a real estate presentation, such as an open house presentation, using a presentation or open house module of a real estate listing system. The open house module and the real estate listing system can be any of the modules and systems described or otherwise envisioned herein. At 404 a user is authenticated, such as through an email service 402 or any other authentication method. At 406, if the email is validated and the new or returning user has setup a password, the system progresses to step 408 (if not, the system can return to the beginning or end). At 408, the user is onboarded, which can encompass any method or system and information for onboarding. At 410, the user gets access to the access dashboard via which the user can see information about existing listings or provide new information for new listings. At step 412 of the method, the user creates a new open house presentation as described or otherwise envisioned herein. For example, the user can provide or link to or import or otherwise give or find or receive information about a real estate listing for a presentation. For example, at step 414 the user can select one of a plurality of possible templates for the presentation. At step 416, the user can provide text, images, video, or anything else for the presentation. At step 420, the system saves the presentation information in local and/or remote storage, such as cloud server 418. At step 424, the system publishes the presentation, for example making the presentation available for viewers, resulting in an available published presentation at step 426. If there are any issues or the presentation is inactivated or not utilized, the system may comprise an unpublished presentation 428 or 422, and may need more information.

At step 112 of the method, the real estate listing system 200 receives a communication request from a viewer of the open house presentation. For example, a user or viewer of the virtual open house presentation submits a communication request via a user interface to the system by clicking a button or activating another user-activated option for initiating or requesting contact. That request is communicated via the user's browser or other visualization method or user interface to the real estate listing system 200 via the wired and/or wireless communication network. According to an embodiment, the real estate listing system 200 comprises a communication module configured to: (i) receive the communication request from the presentation viewer or potential purchaser; and (ii) communicate the communication request to an entity such as real estate agent or other communicative entity.

At step 114 of the method, the real estate listing system 200 transmits the received communication request to an outlet, recipient, or receiver that is configured to receive and potentially act on the received communication request. For example, the real estate listing system 200 can transmit the received communication request vie the wired and/or wireless communication network to a real estate agent, real estate brokerage, or other recipient. For requests to communicate by text or telephone, the real estate listing system 200 can transmit the received communication request to the recipient via a telecommunications network, such as to a phone or other communication device. For online chat or video call, the real estate listing system 200 can transmit the received communication request to the recipient via a telecommunications network to make a direct or immediate communication with the recipient. Many other connections and communication methods are possible.

Referring to FIG. 2 is a schematic representation of a real estate listing system 200. System 200 may be any of the systems described or otherwise envisioned herein, and may comprise any of the components described or otherwise envisioned herein. It will be understood that FIG. 2 constitutes an abstraction and that the components of system 200 may be different and more complex than illustrated.

According to an embodiment, system 200 comprises a processor 220 capable of executing instructions stored in memory 230 or storage 260 or otherwise processing data to, for example, perform one or more steps of the method. Processor 220 may be formed of one or multiple modules. Processor 220 may take any suitable form, including but not limited to a microprocessor, microcontroller, multiple microcontrollers, circuitry, field programmable gate array (FPGA), application-specific integrated circuit (ASIC), a single processor, or plural processors.

User interface 240 may include one or more devices for enabling communication with a user. The user interface can be any device or system that allows information to be conveyed and/or received, and may include a display, a mouse, and/or a keyboard for receiving user commands. In some embodiments, user interface 240 may include a command line interface or graphical user interface that may be presented to a remote terminal via communication interface 250. The user interface may be located with one or more other components of the system, or may located remote from the system and in communication via a wired and/or wireless communications network. Communication interface 250 may include one or more devices for enabling communication with other hardware devices. Various alternative or additional hardware or configurations for communication interface 250 will be apparent.

Storage 260 may include one or more machine-readable storage media such as read-only memory (ROM), random-access memory (RAM), magnetic disk storage media, optical storage media, flash-memory devices, or similar storage media. In various embodiments, storage 260 may store instructions for execution by processor 220 or data upon which processor 220 may operate. For example, storage 260 may store an operating system 261 for controlling various operations of system 200.

According to an embodiment, storage 260 of system 200 may store one or more algorithms, modules, and/or instructions to carry out one or more functions or steps of the methods described or otherwise envisioned herein. For example, processor 220 may comprise, among other instructions or data, virtual open house presentation instructions 262 and/or communication instructions 263.

According to an embodiment, virtual open house presentation instructions 262 direct the system to generate a virtual open house presentation from real estate and/or property information. For example, the virtual open house presentation instructions or module can be configured to generate and provide a virtual open house presentation. The virtual open house presentation can comprise any information about the real estate listing. For example, the presentation can comprise one or more of pricing information about the property, pictures and/or videos of the property, a virtual tour of the property, an interactive neighborhood map, sold comparable listings, development information, open house information, information about a brokerage listing the property, and/or information about a real estate agent listing the property, among many other types of information. The virtual open house presentation can be generated by the virtual open house presentation module from information stored or otherwise found entirely within the real estate listing system 200, or can comprise information from both: (1) the real estate listing system; and (2) one or more external databases or other sources of information, wherein the real estate listing system is in communication with the one or more external databases and is configured to receive or request information from the databases. The virtual open house presentation instructions 262 can be further configured to provide the generated open house presentation. According to an embodiment, the system may provide the generated open house presentation upon receiving a request from a remote user. According to an embodiment, the system transmits a stored virtual open house presentation to a user's browser via the internet. The viewed presentation can be manipulatable in one or more ways, including options to stop or start the presentation, links for more information, and other manipulations.

According to an embodiment, communication instructions 263 direct the system to be able to receive a communication request from a viewer of the open house presentation. For example, a user or viewer of the virtual open house presentation submits a communication request via a user interface to the system by clicking a button or activating another user-activated option for initiating or requesting contact. That request is communicated via the user's browser or other visualization method or user interface to the real estate listing system 200 via the wired and/or wireless communication network. According to an embodiment, the real estate listing system 200 comprises the communication instructions 263 and/or a communication module configured to: (i) receive the communication request from the presentation viewer or potential purchaser; and (ii) communicate the communication request to an entity such as real estate agent or other communicative entity. The communication instructions 263 further direct the system to transmit the received communication request to an outlet, recipient, or receiver that is configured to receive and potentially act on the received communication request. For example, the real estate listing system 200 can transmit the received communication request vie the wired and/or wireless communication network to a real estate agent, real estate brokerage, or other recipient.

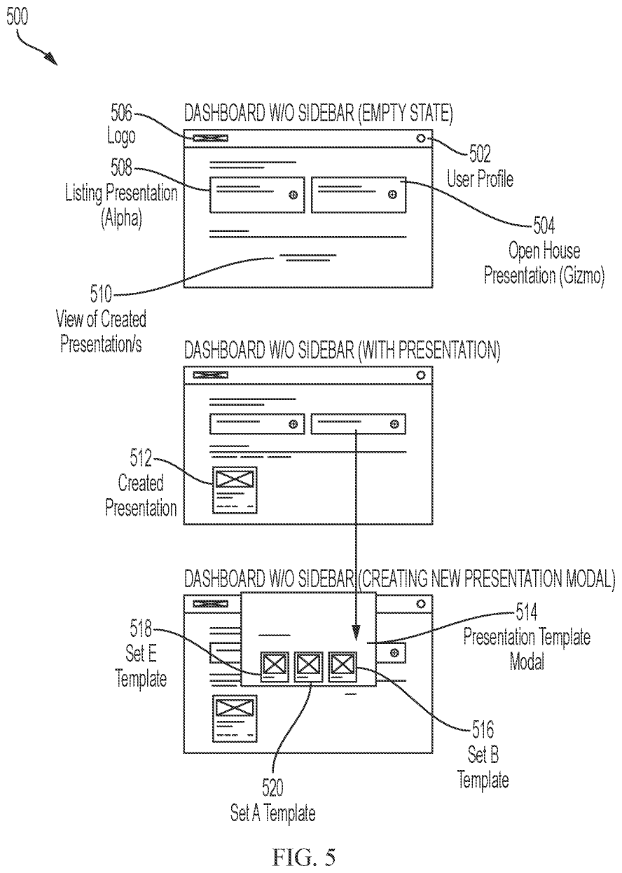

Referring to FIG. 5, in one embodiment, is a schematic representation of a dashboard module 500 of a real estate listing system, in accordance with an embodiment. The dashboard module and real estate listing system can be any of the modules and systems described or otherwise envisioned herein. According to an embodiment, the dashboard module comprises one or more of a user profile 502, an open house presentation module (Gizmo) 504, a logo 506 such as a logo for the real estate agent or brokerage, a listing presentation module (Alpha) 508, a view of existing or created presentations 510, created presentations 512, a presentation template modal 514 providing access to templates such as presentation template set B 516, presentation template set E 518, OR presentation template Set A 520, among other components.

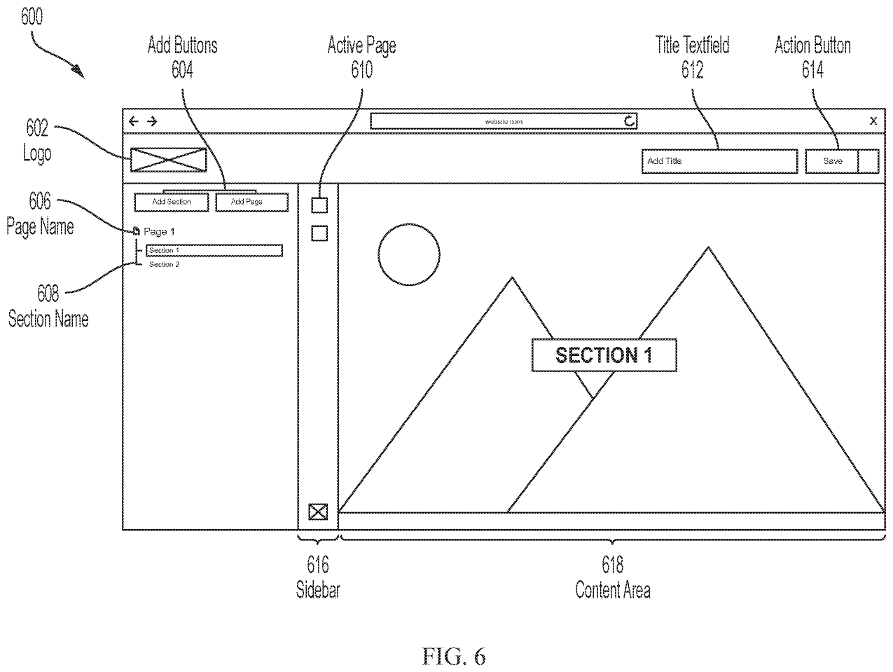

FIG. 6 is a schematic representation of a presentation editor module 600 of a real estate listing system, in accordance with an embodiment. The presentation editor module and real estate listing system can be any of the modules and systems described or otherwise envisioned herein. According to an embodiment, the presentation editor module comprises one or more of a logo 602 such as a logo for the real estate agent or brokerage, buttons 604 to add components such as a section or a page, the page name editor 606, a section name editor 608, an active page indicator 610, a title text field 612, an action button 614, a sidebar 616, and a content area 618, among other components.

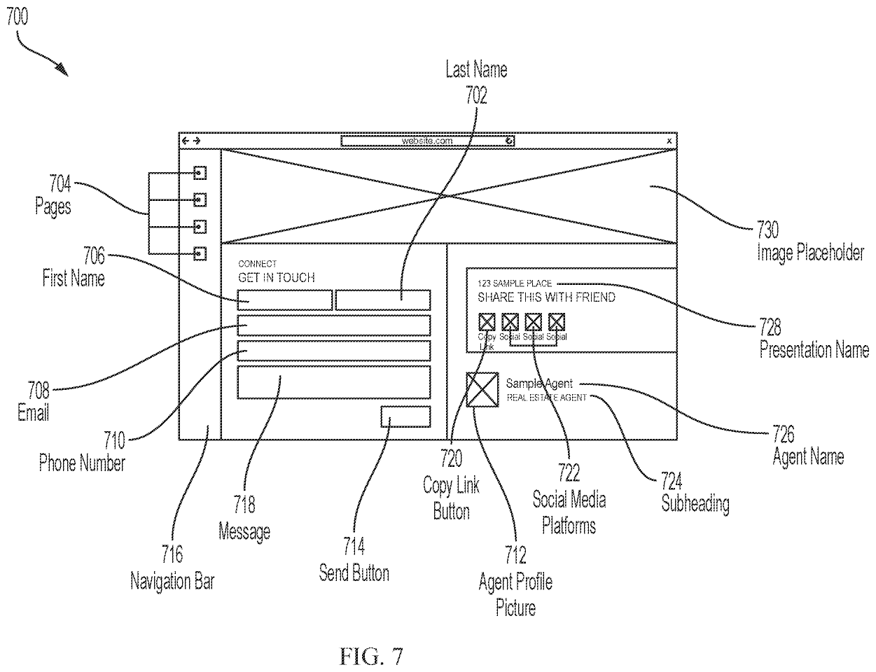

FIG. 7 is a schematic representation of a communication module 700 of a real estate listing system, in accordance with an embodiment. The communication module and real estate listing system can be any of the modules and systems described or otherwise envisioned herein. According to an embodiment, the communication module comprises one or more of a field entry system comprising fields for first name 706, last name 702, email 708, phone number 710, message 718, and send button 714. The communication module also comprises one or more of a link to other pages 704 in a navigation bar 716, an image placeholder 730, presentation name 728 with social media platform links 722 and copy link button 720, agent name 726 and agent profile picture 712 and subheading 724, among other components.

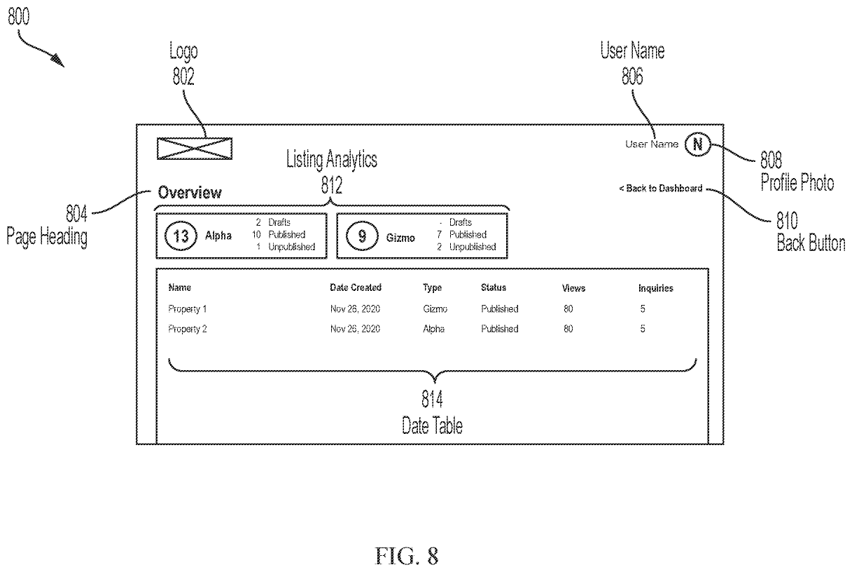

FIG. 8 is a schematic representation of an overview module 800 of a real estate listing system, in accordance with an embodiment. The overview module and real estate listing system can be any of the modules and systems described or otherwise envisioned herein. According to an embodiment, the overview module comprises one or more of a logo 802 such as a logo for the real estate agent or brokerage, a page heading 804, listing analytics 812 and database 814, with username 806 and profile photo 808, as well as a back button 810, among other components.

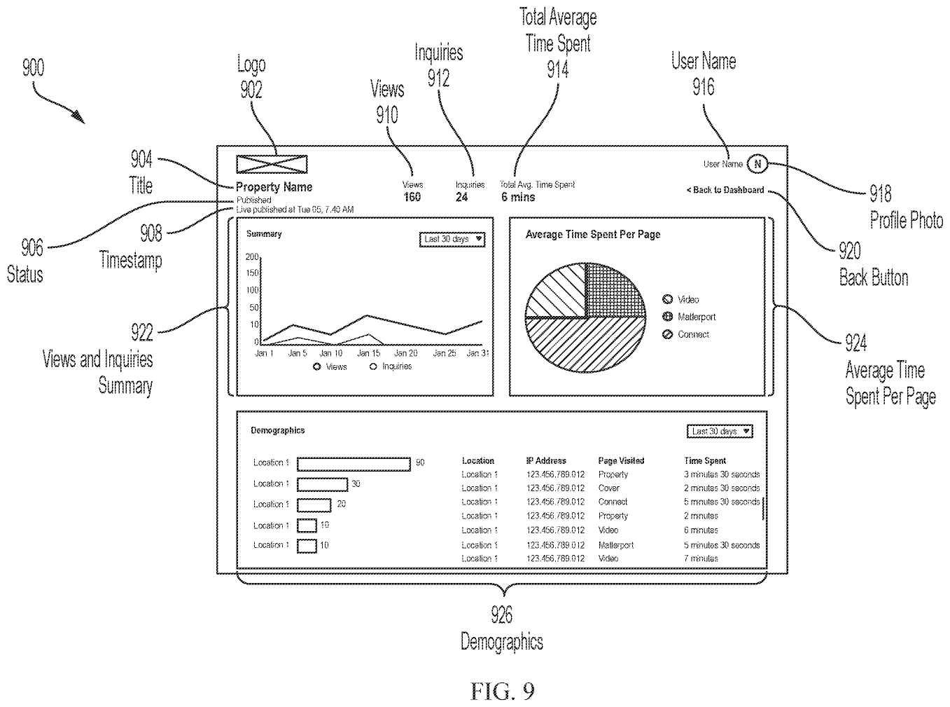

FIG. 9 is a schematic representation of an overview listing module 900 of a real estate listing system, in accordance with an embodiment. The overview listing module and real estate listing system can be any of the modules and systems described or otherwise envisioned herein. According to an embodiment, the overview listing module comprises one or more of a logo 902 such as a logo for the real estate agent or brokerage, a property name or title 904, a status 906, a timestamp 908, a username 916 and profile photo 918, and a back button 920. The overview listing module further comprises statistics information such as one or more of views and inquiries summary 922, average time spent per page 924, demographics 926, views 910, inquiries 912, and total average time spent 914, among other components.

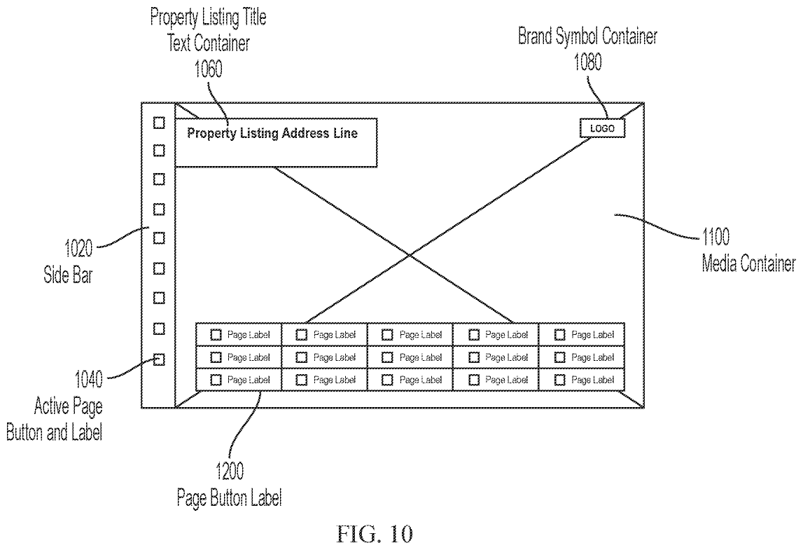

FIG. 10 is a schematic representation of a cover section for an online listing presentation and open house products of a real estate listing system, in accordance with an embodiment. The cover section can be any of the modules or systems described or otherwise envisioned herein. According to an embodiment, the cover section comprises one or more of a property listing title text container 1060, brand symbol container 1080 for content such as a logo for the real estate agent or brokerage, media container 1100, side bar 1020 with pages such as active page button and label 1040, and further comprises pages with page button label 1200, among other components.

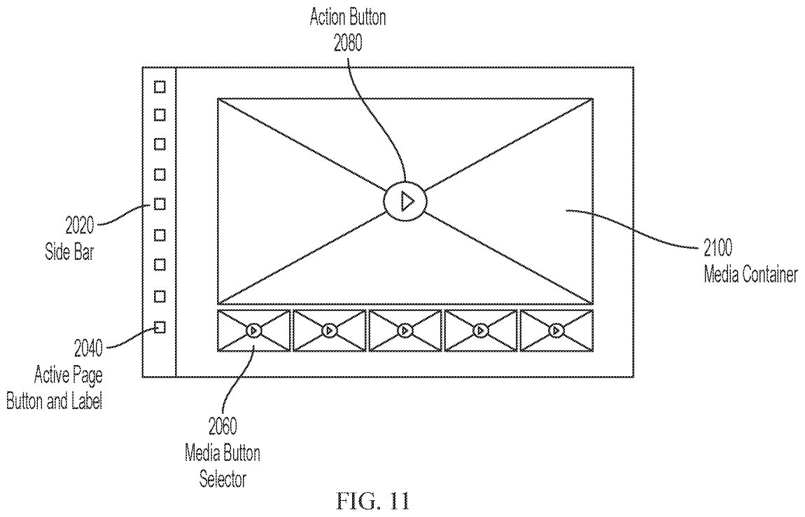

FIG. 11 is a schematic representation of a media gallery section for an online listing presentation and open house products of a real estate listing system, in accordance with an embodiment. The media gallery section can be any of the modules or systems described or otherwise envisioned herein. According to an embodiment, the media gallery section comprises one or more of a side bar 2020 with pages such as active page button and label 2040, media container 2100 with action button 2080, and media button selector 2060, among other components.

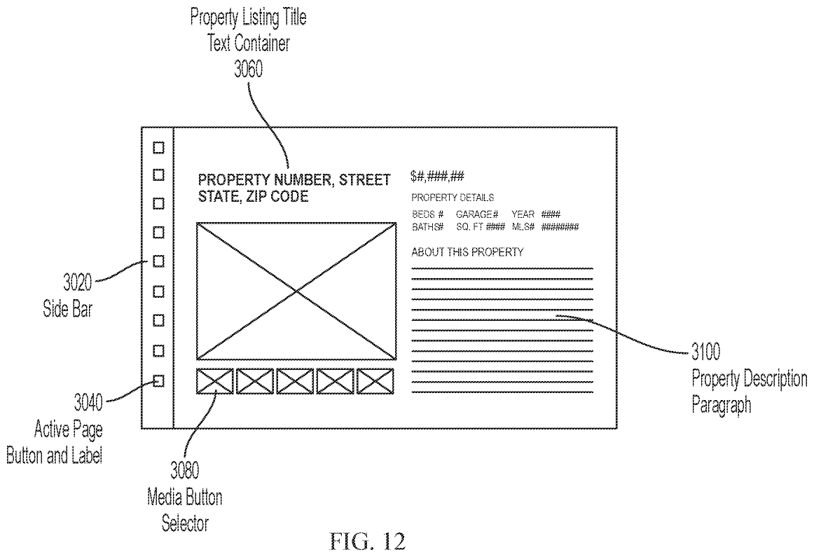

FIG. 12 is a schematic representation of a property information section for an online listing presentation and open house products of a real estate listing system, in accordance with an embodiment. The property information section can be any of the modules or systems described or otherwise envisioned herein. According to an embodiment, the property information section comprises one or more of a property listing title text container 3060, side bar 3020 with pages such as active page button and label 3040, a media button selector 3080, and property description paragraph 3100, among other components.

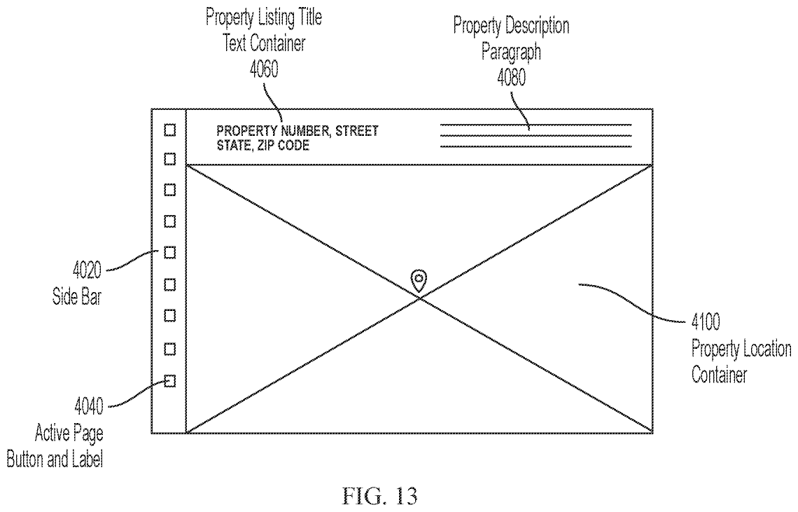

FIG. 13 is a schematic representation of a property map section for an online listing presentation and open house products of a real estate listing system, in accordance with an embodiment. The property map section can be any of the modules or systems described or otherwise envisioned herein. According to an embodiment, the property map section comprises one or more of a property listing title text container 4060, side bar 4020 with pages such as active page button and label 4040, a property description paragraph 4080, and a property location container 4100, among other components.

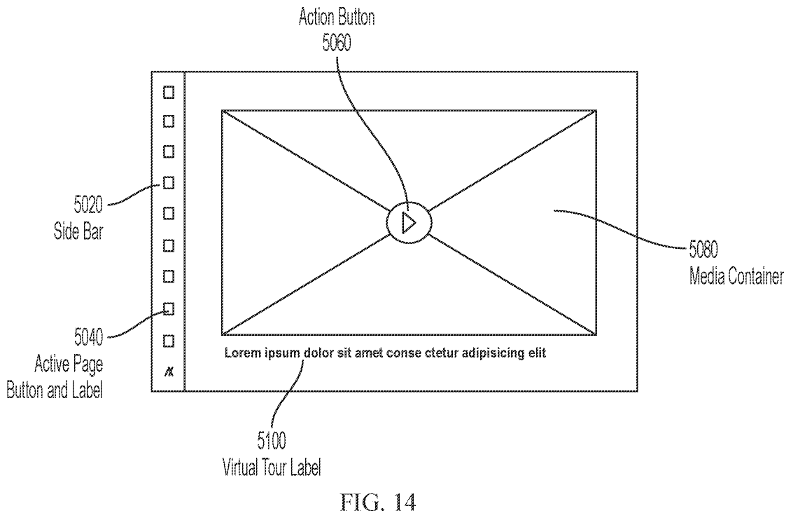

FIG. 14 is a schematic representation of a virtual tour section for an online listing presentation and open house products of a real estate listing system, in accordance with an embodiment. The virtual tour section can be any of the modules or systems described or otherwise envisioned herein. According to an embodiment, the virtual tour section comprises one or more of a side bar 5020 with pages such as active page button and label 5040, a virtual tour label 5100, and a media container 5080 with an action button 5060, among other components.

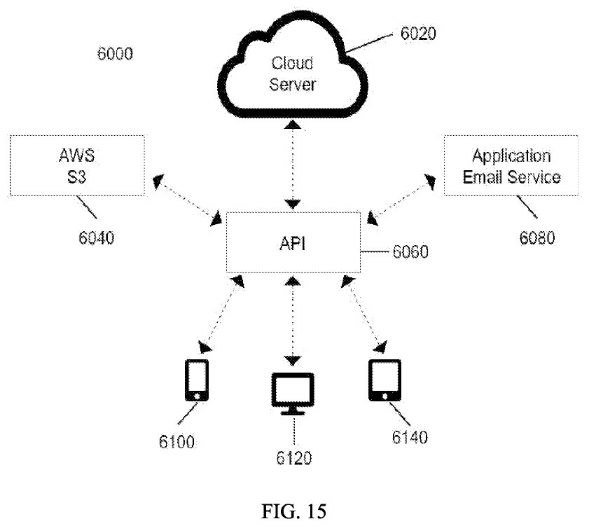

FIG. 15 is a schematic representation of a real estate listing system 6000, in accordance with an embodiment. The real estate listing system can be any of the modules or systems described or otherwise envisioned herein. According to an embodiment, the real estate listing system comprises one or more of a cloud server 6020, an online storage service such as AWS S3 6040, an application email service 6080, an API 6060, and one or more remote devices such as 6100, 6120, and 6140, among other components.

### Example 1—The Online Listing Presentation & Open House Products

The disclosure will be further illustrated with reference to the following specific example. It is understood that this example is given by way of illustration and is not meant to limit the disclosure or the claims to follow. The methods and systems described in conjunction with the example may be one or more of the embodiments described or otherwise envisioned herein.

According to an embodiment, the system comprises a two-part, sister product system designed to improve an agent's ability to digitally represent themself, their brokerage, and ultimately a listing. According to an embodiment, the real estate listing system comprises an online listing presentation component or module. The tool is designed to enhance an agent's listing presentation digitally in their effort to land a listing (i.e., sign as the owner's listing agent). According to an embodiment, the tool is branded to the agent and/or their brokerage to give the agent an advantage over the competition in winning the listing. According to an embodiment, the tool features photos, videos, interactive map, details, etc. that are either general or specific to the listing at hand. In addition, marketing collateral to what many agents refer to as a pitch book. According to an embodiment, some or all of the elements are tied together in a branded package with the agent's information and the ability to share.

According to an embodiment, the real estate listing system comprises an online open house component or module. The tool brings together multiple technologies that agents look to when providing an online experience of a given listing. The agent has landed the listing and now it's time to put the client's listing in the best light possible. Everything is in one spot except smell. Now that the agent has obtained all listing information, the details can be provided just as they would with any listing details page, and including any property photos, floor plans, and videos. In addition, the tool can provide an interactive map with information about the area, as well as the ability to incorporate other third-party tools, such as interactive 3D walkthroughs. The tool can include branding for the agent. One option is a Connect button prominently featured at any given moment of the tool's use. The Connect button puts the visitor in touch with the listing agent via chat, message, appointment request, video call, and allows for sharing across various avenues such as social media, email, and text. Whoever the link, app, or tool is shared with, the listing agent receives that information.

The real estate listing system can also comprise one or more of a buyers' tool, and an automated unbranded version of the Online Open House for each listing. According to an embodiment, the tools provided by the system are user friendly on both ends (front and back). Indeed, the products are configured for user control.

According to an embodiment, for the Listing Presentation, the agent will be able to upload their own information, control which tabs will be shown, and even control tab names. It is easy to create new pages. Once created, the agent will be able to update and reuse the presentation template to fit the needs of multiple listings. This provides the agent with the ability to have multiple listing presentations out at any given time. According to an embodiment, things like videos, photos, property details, and the map will be updated with new information for the new listing prospect, while much of the marketing, branding, and agent information will likely be reused until the agent feels it needs updating. According to an embodiment, on the user/public side of the Listing Presentation, the more self-explanatory the information, the better. According to an embodiment, the system comprises large style buttons and presentation flow that enables the potential client (seller) to use and understand with ease.

According to an embodiment, for the virtual presentation or Open House, once developed the agent has the ability on the backend to create/generate new open houses and run multiple at any given time. According to an embodiment, the dashboard will be the agent's backend control center to manage, edit, create, and delete open houses. With the open house, the agent will have access to all property information, photos, floor plans, videos, and other 3rd party tools they would like to use. On the user/public side of the Open House, keeping it self-explanatory is key. Large style buttons and presentation flow allow for anyone viewing to use and understand with ease with the easy to find call to action to reach the listing agent and/or share. When used to its maximum capability by the agent, a user can experience everything the property has to offer and more.

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A computerized system for real estate listings, comprising:
a listing module, comprising a backend interface configured to receive information about a real estate listing, the listing module further configured to store the received information in a centralized real estate listing database, wherein the information about the real estate listing comprises a virtual open house presentation, the virtual open house presentation comprising pricing information about the property, pictures and/or videos of the property, a virtual tour of the property, and an interactive neighborhood map;
a virtual open house module configured to provide the virtual open house presentation to a potential purchaser of the real estate listing via an online interface, wherein the virtual open house presentation comprises a contact feature enabling the potential purchaser to contact a real estate agent by text, email, telephone, online chat, or to conduct a video call with the real estate agent; and
a communication module configured to: (i) receive a request from the potential purchaser to contact the real estate agent or to conduct the video call with the real estate agent; and (ii) communicate the request to the real estate agent.

2. The computerized system of claim 1, wherein the information about the real estate listing further comprises one or more of sold comparable listings, development information, open house information, information about a brokerage listing the property, and information about a real estate agent listing the property.

3. The computerized system of claim 1, wherein the virtual open house presentation further comprises a floorplan for the property, and one or more links for sharing the real estate listing by social media or email.

4. The computerized system of claim 1, wherein the interactive neighborhood map comprises information about one or more of a local school, restaurant, shop, park, and museum, and further comprises demographic information about the neighborhood.

5. The computerized system of claim 1, wherein the centralized database comprises information about a plurality of real estate listings, and wherein the plurality of real estate listings are searchable by the potential purchaser.

6. The computerized system of claim 1, wherein the virtual open house presentation comprises branding of the real estate agent or a brokerage listing the property.

7. The computerized system of claim 1, wherein the virtual open house presentation comprises a testimonial about the real estate agent or a brokerage listing the property.

8. The computerized system of claim 1, wherein at least a portion of the virtual open house presentation is three-dimensional.

9. The computerized system of claim 1, wherein virtual open house presentation comprises a template configured for construction of the virtual open house presentation.

10. The computerized system of claim 1, wherein at least a portion of the virtual open house presentation is automatically updated with new information.

11. A method for providing a real estate listing, comprising:
providing a real estate listing system comprising: (i) a listing module configured to receive information about a real estate listing and (ii) a virtual open house module configured to generate and provide a virtual open house presentation to a potential purchaser of the real estate listing via an online interface;
receiving, by the listing module, the information about the real estate listing;
generating, by the virtual open house module using the received information about the real estate listing, the virtual open house presentation, wherein the virtual open house presentation comprises a contact feature;
providing the generated virtual open house presentation to a viewer;
receiving, by the real estate listing system from the viewer via the contact feature, a communication request from the viewer about the virtual open house presentation; and
communicating the received communication request.

12. The method of claim 11, wherein the virtual open house presentation comprises one or more of pricing information about the real estate listing, pictures and/or videos of the real estate listing, a virtual tour of the real estate listing, and an interactive neighborhood map.

13. The method of claim 11, wherein the information about the real estate listing further comprises one or more of sold comparable listings, development information, open house information, information about a brokerage listing the real estate listing, and information about a real estate agent listing the real estate listing.

14. The method of claim 11, wherein the virtual open house presentation further comprises a floorplan for the property, and one or more links for sharing the real estate listing by social media or email.

15. The method of claim 12, wherein the interactive neighborhood map comprises information about one or more of a local school, restaurant, shop, park, and museum, and further comprises demographic information about the neighborhood.

16. The method of claim 11, wherein the virtual open house presentation comprises branding of the real estate agent or a brokerage listing the property.

17. The method of claim 11, wherein the virtual open house presentation comprises a testimonial about the real estate agent or a brokerage listing the property.

18. The method of claim 11, wherein at least a portion of the virtual open house presentation is three-dimensional.

19. The method of claim 11, wherein the virtual open house presentation comprises a template configured for construction of the virtual open house presentation.

20. The method of claim 11, wherein at least a portion of the virtual open house presentation is automatically updated with new information.
